(19) United States
(12) Patent Application Publication
(10) Pub. No.: US 2004/0065732 A1
(43) Pub. Date: Apr. 8, 2004

(54) System for contactless registration of information stored on electronic tags

(76) Inventors: Adolf Bernds, Baiersdorf (DE); Wolfgang Clemens, Puschendorf (DE); Walter Fix, Nurnberg (DE); Henning Rost, Erlangen (DE)

Correspondence Address: YOUNG & THOMPSON, 745 SOUTH 23RD STREET 2ND FLOOR, ARLINGTON, VA, 22202

(21) Appl. No.: 10/468,773

(22) PCT Filed: Feb. 18, 2002
(86) PCT No.: PCT/DE02/00580

(30) Foreign Application Priority Data
Feb. 21, 2001 (DE) 10108428.5
Jul. 19, 2001 (DE) 10134410.4

(51) Int. Cl. G06K 15/00; G06F 17/60

(52) U.S. Cl. 235/383; 235/385

(57) ABSTRACT

The invention relates to a system for contactless registration of information stored on electronic tags, comprising at least one receiving device (1), embodied in the form of a container, tub, basket or the like, with an opening (2) for receiving electronic tags, a detection device (3) associated with the at least one receiving device (1) for receiving information from the electronic tags, and a read device (4) for processing information received from the receiving device.

The present invention relates to a system for contactless registration of information stored on electronic tags.

Electronic tags, referred to as ‘ident-tags’, can be applied in many aspects of daily life, in particular for the labeling of goods and/or products. They can contain diverse types of information on the type, characteristics, quantity or price of a product, thus simplifying the corresponding logistics. They can be consulted as a source of information when storing and/or drawing up an inventory of products.

One area in which electronic tags have still not found much acceptance is in retailing, in other words in the labeling of goods and/or products for sale in department stores, hypermarkets and the like. This is because tags have been too expensive to date, to fit to every article. This problem can be resolved by introducing very cost-effective electronic tags on the basis of organic electronics.

Devices referred to as electronic anti-theft devices are already known in department stores. Specific goods that are easy to steal are fitted with special pins, which generate a warning signal once they are taken past an antenna system, if they are not removed on payment at a point of sale. A shopping cart for example can also be pushed past a similar antenna system to register its contents. However this presents the problem that all items in the shopping cart will generate a signal at the antenna at the same time. The information registered would be too inaccurate due to the superimposing of the signals generated.

The object of the present invention is to specify a system that can be used simply and reliably for the contactless registration of information stored on electronic tags, for example the price of goods. It should be possible to use this system in particular in department stores and hypermarkets, replacing the standard points of sale.

The object of the present invention is a system according to the invention for contactless registration of information stored on electronic tags, comprising at least one receiving device, embodied in the form of a container, tub, basket or the like, with an opening for receiving electronic tags, a detection device associated with at least one receiving device for detecting information on electronic tags and a read device for processing information received from the detection device.

An item of goods that is fitted with an electronic tag generates a separate data signal in the associated detection device when the item is placed into the receiving device through the opening, with this signal, whether processed or not, being forwarded to a read device for further processing. This avoids the superimposing of individual information signals received from more than one electronic tag.

For this purpose, it is advantageous to locate the detection device associated with at least one receiving device in the area of the opening of the receiving device. This ensures the very accurate receipt of information at the detection device via the electronic tag. It avoids the registration and/or receipt of information on goods that are not placed into the receiving device.

For this purpose, it is furthermore advantageous for the detection device to be embodied in a circular or similar shape. Users do not have to take into consideration where the electronic tag is located on the item, for the detection device to register the information it contains. This will also largely exclude the system from being misused with the intention of preventing information from being registered.

This effect is supported in that, in a further advantageous embodiment of the invention, the detection device is essentially provided in the area of the circumference of the opening.

The read device, which is associated with the detection device, is advantageously embodied such that it collects and/or totals and/or stores the information received. It is therefore suitable for receiving information on the type, quantity, characteristics or price of an item and for processing this information depending on the parameter. It must be possible in any event to retrieve the information.

It is advantageous for users to have a display device associated with the read device to ensure the visual and/or acoustic output of information that has been collected and/or totaled and/or stored. This further embodiment permits users to check the goods that have already been placed in the receiving device, depending on the information contained in the tag, and if necessary to adjust it. If, for example, an item is incorrectly or unintentionally placed in the receiving device, it is possible to remove it again and the corresponding information stored is cancelled.

A display, for example in the form of an LED display, advantageously serves as the visual display. Information relating to the type, characteristics, weight, and price of the item can be conveyed, if it is stored in the electronic tag. The display device for acoustically conveying information is advantageously a loudspeaker, which acoustically conveys the electronically stored information using the read device. This loudspeaker can also convey interesting information to the system user, irrespective of the information on the electronic tag.

It is furthermore advantageous for the read device to communicate with an evaluation or similar device, which evaluates and/or further processes the information collected and/or totaled and/or stored by the read device. This evaluation or similar device may be an integral component of the read device, but is preferably a component of a central system, which receives, evaluates and/or further processes corresponding signals from read devices, and if necessary returns the processed information to the read device.

In a further advantageous embodiment of the invention, the read device is provided in at least one receiving device to process the information received from the detection device. This means that the information received can be processed as decentrally as possible. For cost reasons, however, the read device can also be provided in a central unit, from which the processed information can be retrieved.

It is therefore essential that the read device and central unit communicate via a transmit/receive device. Such a transmit/receive device comprises a transmitter assigned to the read device on at least one receiving device and a receiver in the central unit. The receive device and/or the transmit/receive device, receives and/or transmits the information via radio and/or infrared and/or ultrasound.

According to a particular aspect of the present invention, the receiving device is embodied in the form of a movable object. In particular it is a shopping cart or similar shopping basket. The information stored on the electronic tag is preferably the price of an item, so that the system according to the invention can be used for the contactless registration of prices of goods stored on electronic tags. Individual points of sale to add up the prices of the individual goods would therefore become superfluous.

For this purpose, the evaluation or similar device referred to above is advantageously embodied in the form of a chipcard device and/or chipcard reader, which receives the information determined by the read device and transmits it to a banking establishment for payment. Standard EC or credit cards can be used for this purpose. It is also possible for users to deploy, for example, a monetary value chipcard, i.e. a chipcard loaded with a specific amount of money.

The read device and/or display device and/or evaluation or similar device is/are advantageously provided in the handle of the shopping cart or similar shopping basket. This provides relative protection for these essential system elements against impact and would prevent them in particular from being tampered with.

The chipcard reader does not necessarily have to be an integral component of the shopping cart. Such devices can also be provided at the exit of the department store. In any event, communication systems that are suitable and known according to the prior art must be used to ensure that the shopping cart is not released until the good it contains has been paid for.

The present invention is further described below using a preferred exemplary embodiment and in particular using the drawings, which show:

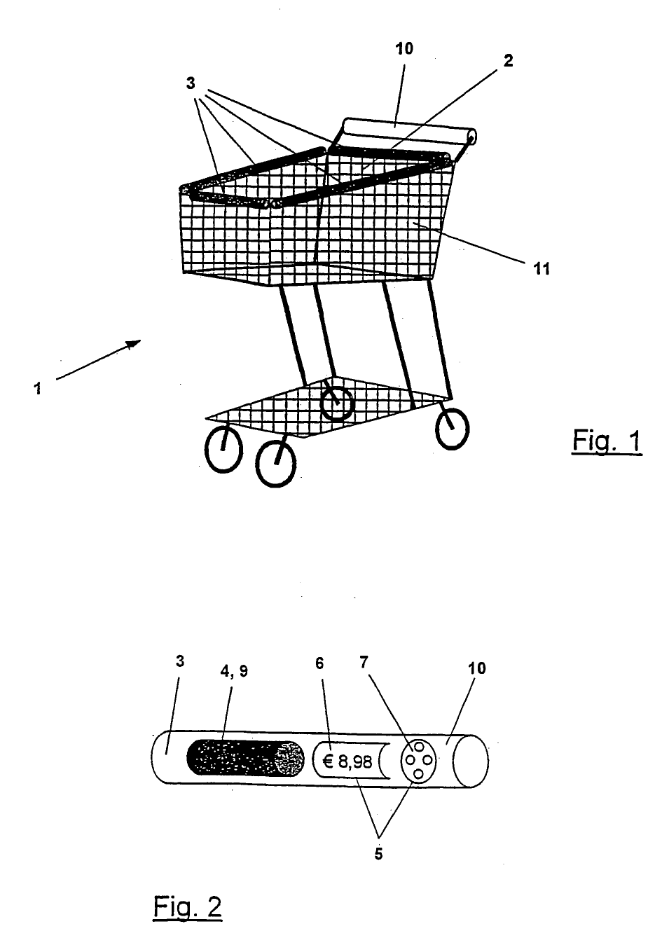

FIG. 1 a shopping cart equipped according to the invention;

FIG. 2 a schematic view of individual elements of the system according to the invention, provided in a handle.

The receiving device shown in FIG. 1 is a standard, mobile shopping cart (1) having a shopping basket (11) and a handle (10). The shopping basket (11) comprises the detection device provided in the form of an antenna (3) in the area of the circumference of the opening (2). The antenna (3) emits an electromagnetic field. The electronic tags, referred to as RFID tags, cause a power loss in this field, which is detected by the antenna (3) and forwarded to the read device (4). The power loss corresponds to the information contained in the tag. The antenna (3) can also be used to receive radio frequency signals which are emitted by electronic tags. As soon as an item, which is provided with an RFID tag, is placed in the shopping basket (11) through the opening (2) thereof, the antenna (3) receives corresponding RF signals. These signals correspond to information stored in the identtag, for example the price.

FIG. 2 shows a schematic view of individual elements of the system according to the invention. The handle (10) contains a read device (4) which is associated with the antenna (3). The read device (4) receives corresponding information signals from the antenna (3), for example about the price. The read device (4) collects and/or totals and/or stores this information. In the embodiment shown, the handle furthermore comprises a display device (5) in the form of a display (6) which visually conveys information to the user. The read device (4) and display (6) are connected to each other to enable communication.

If a user places an item fitted with an electronic tag in the shopping basket (11), the antenna (3) initially registers the corresponding information on the item as described above and then forwards this information to the read device (4) in a suitably processed format.

The read device (4) forwards predefined information on the item, for example type, characteristics, quantity and/or price, to the display device (5), which visualizes the corresponding information in the display (6), for example in the form of an LED display. If, for example, the price of a product depends on its weight, it is possible for the display (6) to show first the weight, and then the price. In this way, users are able to remove the product in question from the shopping basket (11) if they do not want it. The antenna (3) then registers a ‘negative’ signal, which is forwarded to the read device (4) for further processing. The information registered is deleted. In any event, the display (6) is configured in such a way that users can continually receive information about the price of an individual product and then the total of all products already placed in the shopping basket (11).

This information can in theory also be provided via a loudspeaker (7), which must again be suitably connected to the read device (4) to enable communication. The loudspeaker (7) can also be used to convey non-product-related information to the person using the shopping cart (1), for instance in a hypermarket which has many different product areas. As soon as a person using a shopping cart (1) moves from the food department to the household goods department or home improvements department, they can for example be notified acoustically of other offers in this department.

In another embodiment of the shopping cart (1) according to the invention, the read device (4) can also be provided in a central unit, which is separate from the shopping cart (4). In this way, the read device (4) and/or the overall system is equipped with a transmit/receive unit (8) (not shown), with the transmitter (9) being integrated in the handle (10) of the shopping cart (11) instead of the read device (4). In any event, the read device (4) is associated with an evaluation or similar device, with which it communicates. The transmitter (9) transmits corresponding information to a central read device (4), which collects and/or totals and/or stores the information.

The evaluation or similar device (not shown) can be a chip reader for example, which is also provided on the shopping cart (1) or in a central unit. Once the person using the shopping cart (1) has finished shopping, they can release the shopping cart (1) by paying the total amount. This can be done by inserting an EC or other card to pay for the goods electronically. The card can be inserted either in a chip reader on the shopping cart or on a central unit or even on a fixed unit, for example in the vicinity of an exit, such as a former point of sale, for debiting.

1. System for contactless registration of information stored on electronic tags, comprising at least one receiving device (1), embodied in the form of a container, tub, basket or the like, with an opening (2) for receiving electronic tags, a detection device (3) associated with at least one receiving device (1) for detecting information on the electronic tags and a read device (4) for processing information received from the detection device.

2. System according to claim 1, characterized in that the detection device (3) associated with at least one receiving device (1) is provided in the area of the opening (2) of the receiving device (1).

3. System according to claim 1 or 2, characterized in that the detection device (3) is embodied in a circular or similar shape.

4. System according to one of claims 1 to 3, characterized in that the detection device (3) is essentially provided in the area of the circumference of the opening (2).

5. System according to one of claims 1 to 4, characterized in that the read device (4) collects and/or totals and/or stores the information received from the detection device (3).

6. System according to one of claims 1 to 5, characterized in that the read device (4) comprises a display device (5) for the visual and/or acoustic output of the collected and/or totaled and/or stored information.

7. System according to claim 6, characterized in that the display device (5) comprises a display (6) and/or a loud-speaker (7).

8. System according to claim 7, characterized in that the read device (4) communicates with an evaluation or similar device, which evaluates and/or further processes the information collected and/or totaled and/or stored by the read device (4).

9. System according to one of claims 1 to 8, characterized in that the read device (4) is provided on at least one receiving device (1) to process the information received from the detection device (3).

10. System according to one of claims 1 to 8, characterized in that the read device (4) is provided in a central unit to process the information received from the detection device (3).

11. System according to claim 10, characterized in that the read device (4) and central unit communicate via a transmit/receive device.

12. System according to claim 11, characterized in that the transmit/send device comprises a transmitter (9) associated with the read device (4) on at least one receiving device (1) and a receiver in the central unit.

13. System according to one of claims 1 to 12, characterized in that the detection device (3) and/or the transmit/receive device receives and/or transmits the information via radio and/or infrared and/or ultrasound.

14. System according to one of claims 1 to 13, characterized in that at least one receiving device (1) is embodied in the form of a movable object.

15. System according to claim 14, characterized in that at least one receiving device is embodied in the form of a shopping cart (1) or similar shopping basket (11).

16. System according to one of claims 1 to 15, characterized in that the information stored on the electronic tag is the price of an item.

17. System according to one of claims 8 to 16, characterized in that the evaluation or similar device is embodied in the form of a chipcard device, which receives the information determined by the read device (4) and transmits it to a banking establishment for payment.

18. System according to one of claims 15 to 17, characterized in that the read device (4) and/or the display-device (5) and/or the evaluation or similar device is/are provided in the handle (10) of the shopping cart (1) or similar shopping basket (11).
